(19) United States
(12) Patent Application Publication
(10) Pub. No.: US 2025/0168210 A1
(43) Pub. Date: May 22, 2025

(54) APPARATUS AND METHODS THEREIN, IN A COMMUNICATIONS NETWORK

(71) Applicant: Telefonaktiebolaget LM Ericsson (publ), Stockholm (SE)

(72) Inventors: Peter ÖKVIST, Luleå (SE); Hans HANNU, Luleå (SE)

(21) Appl. No.: 18/839,553

(22) PCT Filed: Mar. 30, 2022
(86) PCT No.: PCT/EP2022/058508

§ 371 Date: Aug. 19, 2024

(51) Int. Cl. H04L 65/403; G06V 40/16

(52) U.S. Cl. CPC H04L 65/403; G06V 40/172

(57) ABSTRACT

A video stream is provided by a first meeting device. The video stream is displayed at least in a second meeting device in a visual digital meeting. The video stream is provided by a camera targeted towards an environment of a user of the first meeting device. A message is received from the second meeting device. The message includes a request for zooming the displayed video stream to be displayed at the second meeting device. A type of the visual digital meeting determined and any face and/or object present anywhere in the video stream provided by the camera is identified. It is then decided whether the request for zooming fulfils a first criteria based on the determined type and any identified face and/or object present. When the request fulfils the first criteria the requested zooming is allowed, and when the request does not fulfil the requested zooming is denied.

### TECHNICAL FIELD

Embodiments herein relate to an apparatus and methods therein. In some aspects, they relate to controlling a zoom level of a video stream provided by the first meeting device in a communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

An on-line meeting such as a visual digital meeting, relies on that some software and hardware works in meeting devices of participants in the on-line meeting. Some important parts are devices such as computers or similar that run software that support voice and video communication.

Users of devices such as computers or tablets, sometimes want to zoom in to a particular part of a real-time video. For example, when a friend shows her or his new mobile phone, she or he usually needs to put it all in front of a web-camera of the device.

Today there are support for zoom in into higher resolution somewhat in the real-time applications of the meeting devices, or their corresponding web-browser applications. Some applications also allow a remote viewer to control the zoom functionality of the camera.

There are e.g. two methods to accomplish zoom, either optical zoom or digital zoom. In the optical zoom the lens system as such is subject to manipulations. In the digital zoom, sensor data from a digital image sensor such as e.g. Charge-Coupled Device (CCD), or Complementary Metal Oxide Semiconductor (CMOS), etc., are aggregated into a raw and/or compressed image and is further considered to obtain a desired magnification or reduction.

One example of automatic adaptive zoom to accomplish zoom is described in U.S. Pat. No. 10,313,417 B2. The automatic adaptive zoom enables computing devices that receive video streams to use a higher resolution stream when the user enables zoom, so that the quality of the output video is preserved. In some examples, a tracking video stream and a target video stream are obtained and are processed. The tracking video stream has a first resolution, and the target video stream has a second resolution that is higher than the first resolution. The tracking video stream is processed to define regions of interest for frames of the tracking video stream. The target video stream is processed to generate zoomed-in regions of frames of the target video stream.

### Digital Meetings

In many digital meeting applications such as Zoom, Skype, or Teams, a user may select a non-personal background filling image; either for the purpose of showing other meeting attendees some nice vacation imagery, or perhaps not to disclose any personal information.

What personal information a first user is comfortable with sharing with meeting attendees may e.g., depend on meeting context (private, business), cultural aspects, and what may/or may not be associated with trigger words in respective context. The relation to other meeting attendees may also be a factor to consider. In private life among trusted friends of known faiths, religion, etc., a first user may be fine with sharing backdrop ornaments and would even like to put more details, such as e.g. accentuate, or emphasize, certain objects that are considered of personal value. A such action may furthermore even serve for establish common ground among meeting participants. However, on the other hand, in e.g. business context or in situations with unknown meeting participants, such personal details should be suppressed on perhaps even totally concealed.

In a mixed setup where a first user could share some selected object visualization with some meeting participant A, but by some reasons not with the other participant B, the commonly today available solution may be to either not send video to B at all or to conceal all details for all.

### Object Recognition

The progress on computer vision-based object detection is rapidly improving, and state-of-the-art solution running at ordinary laptops as well as in state-of-the-art handheld devices are typically capable of in real-time detect, classify and track a parallel multitude of various objects, such as e.g. a specific person, an animal, a type of vehicle etc.

Microsoft Teams background management provides a possibility for a user to either blur background or substitute blurred or real background with image and/or photo or similar.

Face-tracking or object tracking filters as e.g. available in instant messaging applications such as Snapchat, TikTok, FaceTime, etc., may apply bunny-ears, red nose, whiskers, glasses, hat, etc. to first person's face.

It seems plausible that said applications with added capabilities of object identification and/or classification techniques as described above may be capable of identifying arbitrary object in a user's backdrop also referred to as user environment, and substitute said object accordingly.

With an opportunity to zoom into high-definition video stream comes that certain faces in first person's background such as family members or other non-personal object may be subject to remote-zoom in manner not desired nor really approved by first person. The problem will be further evaluated below.

### SUMMARY

An object of embodiments herein is to improve the way of managing remote zoom in a real-time communication session in a communications network.

According to an aspect of embodiments herein, the object is achieved by a method for controlling a zoom level of a video stream. The video stream is provided by a first meeting device in a communications network. The video stream is displayed at least in a second meeting device in a visual digital meeting. The video stream is provided by a camera targeted towards an environment of a user of the first meeting device. A message is received from the second meeting device. The message comprises a request for zooming the displayed video stream to be displayed at the second meeting device. A type of the visual digital meeting determined and any face and/or object present anywhere in the video stream provided by the camera is identified. It is then decided whether or not the request for zooming fulfils one or more first criteria based on the determined type of the visual digital meeting and any identified face and/or object present in the video stream. When the request for zooming fulfils the one or more first criteria the requested zooming of the displayed video stream to be displayed at the second meeting device is allowed, and when the request for zooming does not fulfil the one or more first criteria the requested zooming of the displayed video stream to be displayed at the second meeting device is denied.

The method may be performed by an apparatus, such as e.g., the first meeting device or the server node.

According to another aspect of embodiments herein, the object is achieved by an apparatus configured to control a zoom level of a video stream to be provided by a first meeting device in a communications network. The video stream is to be displayed at least in a second meeting device in a visual digital meeting, and which video stream is arranged to be provided by a camera targeted towards an environment of a user of the first meeting device. The apparatus is further configured to:
Receive a message from the second meeting device, which message is adapted to comprise a request for zooming the displayed video stream to be displayed at the second meeting device,
determine a type of the visual digital meeting,
identify any face and/or object present anywhere in the video stream provided by the camera,
decide whether or not the request for zooming fulfils one or more first criteria based on the determined type of the visual digital meeting and any identified face and/or object present in the video stream,
when the request for zooming fulfils the one or more first criteria allow the requested zooming of the displayed video stream to be displayed at the second meeting device, and
when the request for zooming does not fulfil the one or more first criteria deny the requested zooming of the displayed video stream to be displayed at the second meeting device.

An advantage of embodiments herein is that they provide a method enabling zoom functionality and different variants of background privacy possibilities of the first meeting device in a video stream displayed at least in the second meeting device in a visual digital meeting. This results in an improved way of managing remote zoom in a real-time communication session in a communications network.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIG. 2 is a flowchart depicting an embodiment of a method herein.

FIGS. 3a-b are schematic block diagrams illustrating embodiments of an apparatus.

FIG. 4 schematically illustrates a telecommunication network connected via an intermediate network to a host computer.

FIG. 5 is a generalized block diagram of a host computer communicating via a base station with a user equipment over a partially wireless connection.

FIGS. 6-9 are flowcharts illustrating methods implemented in a communication system including a host computer, a base station and a user equipment.

### DETAILED DESCRIPTION

As a part of developing embodiments herein a problem was identified by the inventors and will first be discussed.

Currently a stepwise method provides involvement of a video client and a video server for providing excellent quality for zooming in/out in videos. A user of a meeting device may zoom in on the video content using its video application on its meeting device.

Allowing a remote view to control the zoom functionality in a real-time video session, e.g., in a MS Teams meeting, does not make a good experience when there are multiple participants in the session as the zoom done by one user typically would affect the other participants.

Further, an additional limitation of the current way of providing zoom is the resolution of the received video. Eventually when zooming the video, you will see the pixels. The lower the resolution of the received video is the lower is the zoom ratio until the pixels can be seen by the user.

With the opportunity to zoom into high-definition video stream comes that certain faces in first person's background such as family members or other non-personal object may be subject to remote-zoom in manner not desired nor really approved by first person.

Therefore, a mechanism is needed that allows a first person to define in its device, whom of meeting participants that can zoom into what objects and to what extent, e.g. zoom level, such may be allowed.

An object of embodiments herein is to improve the way of managing remote zoom in a real-time communication session in a communications network.

Examples of embodiments herein relate to managing remote zoom in a real-time communication session e.g. a real-time video, depending on zoom-targeted object attributes.

Examples of embodiments herein provide a stepwise method e.g. involving clients and a communication server, for providing meeting participants with means to provide and manage remote zoom by other meeting participants in a first users outbound media stream. This is with respect to what objects that are detected in the outbound media stream, and what first-user attributes that are associated with detected objects and remote users' respective relation with said object and/or attributes.

As hinted above, embodiments provided herein e.g. may have the advantages to provide a method for giving excellent quality for zooming in streaming and/or live video without having to increase the load into the network, i.e., avoiding streaming with too high quality all the time, at the same time as they enable zoom functionality in real-time video communication applications and different variants of background privacy possibilities in the same session with multiple participants.

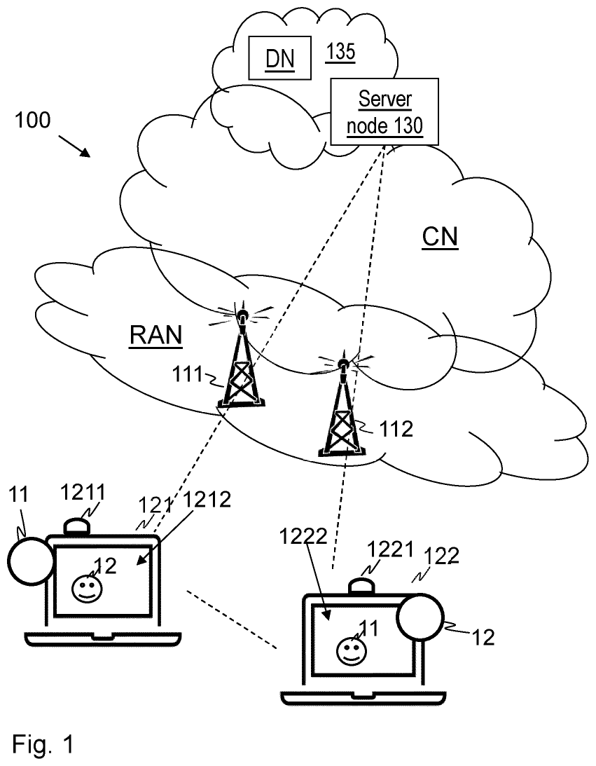

FIG. 1 is a schematic overview depicting a communications network 100 wherein embodiments herein may be implemented. The communications network 100 e.g. comprises one or more RANs and one or more CNs. The communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WIMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

E.g., a number of access points such as a first network node 111 and a second network node 112, operate in the communications network 100. These nodes provide wired coverage or radio coverage in a number of cells which may also be referred to as a beam or a beam group of beams.

The first network node 111, and the second network node 112 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the respective first and second network node 111, 112 depending e.g. on the first radio access technology and terminology used. The first and second network node 111, 112 may be referred to as a serving radio network node and communicates with a UE, such as a meeting device, with Downlink (DL) transmissions to the UE and Uplink (UL) transmissions from the UE.

One or more meeting devices take part in a visual digital meeting in the wireless communication network 100, such as e.g. the first meeting device 121 and the second meeting device 122. The respective first device 121 and the second device 122 may each be represented by a computer, a tablet, a UE, a mobile station, and/or a wireless terminal, capable to communicate via one or more Access Networks (AN), e.g. RAN, e.g. via the first network node 111 and/or the second network node 112, to one or more core networks (CN). A first user 11 uses the first meeting device 121 and a second user 12 uses the second meeting device 122. It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

In an example scenario according to embodiments herein, a video stream is provided by the first meeting device 121 and is displayed at least in the second meeting device 122 e.g. in its display 1222 in a visual digital meeting. The video stream is provided by a camera 1211 targeted towards an environment of the user 11 of the first meeting device 121.

Further, another video stream related to the same visual digital meeting may be provided by the second meeting device 122 and is displayed e.g., in a display 1212 in the first meeting device 121. The other video stream may be provided by a camera 1221 targeted towards an environment of the user 12 of the second meeting device 122.

In an example scenario of the visual digital meeting, the first user 11 sits in front of the display 1212 of the first meeting device 121 and watches the second user 12, and the second user 12 sits in front of the display 1222 of the second meeting device 121 and watches the first user 11.

One or more communication servers, such as e.g. a server node 130 operate in the wireless communication network 100. The server node 130 may be operator owned and may e.g. be located outside or as a part of the CN. The server node 130 e.g. manages video stream displayed in visual digital meetings and may e.g. be a real-time communication server. The server node 130 may e.g., by means if its managing entity, control inbound/outbound video streams to and from its managed users such as the first and second user 11, 12. The server node 130 may be a managing server and/or a controlling node.

Methods herein may be performed by an apparatus 121, 130, such as the first meeting device 121, and/or the server node 130.

As an alternative, a Distributed Node (DN) and functionality, e.g. comprised in a cloud 135 as shown in FIG. 1, may be used for performing or partly performing the methods herein.

A method is provided that enables the second user 12 of the second meeting device 122 to view a good quality zoomed video in visual communications. The first meeting device 121 or the server node 130 provide means to manage what objects and faces in the first meeting device's 121 outgoing video stream that may/may not be zoomed by other meeting participants such as the second meeting device 122.

The user 12 of the second meeting device 122, e.g., a client of an application in the second meeting device 122, requests to zoom in on the current displayed video. Said video is provided by the camera 1211 of the first meeting device 121, which camera 1211 is directed towards the first user 11. The first meeting device 121 or the server node 130 may then determine whether or not to admit the second meeting device 122 to be provided with the requested zoomed media stream targeting some of the faces or objects in providing first meeting device's 121 video stream. The determination whether or not to admit the requested zoomed media stream may be based on a pre-defined set of rules, also referred to as one or more criteria, e.g., relating to users' relations, relation to detected faces in the video stream, type of objects in media stream etc.

If admitted, then first meeting device 122 or the server node 130 may then further provide the requesting second meeting device 122 with a zoomed video stream to a level of zoom that is allowed for considered face/object.

Some embodiments consider at least two visual communicating clients located in smartwatch, smartphones, tablets, or laptops, etc. such as e.g., in the first meeting device 121, and the second meeting device 122. Some embodiments may further consider e.g. the server node 130, that e.g. may be a media server that in some embodiments of the suggested invention may manage in-/outbound media streams between the communication nodes and/or carry out object recognition and thereof associated zoom-rules.

A number of embodiments will now be described, some of which may be seen as alternatives, while some may be used in combination.

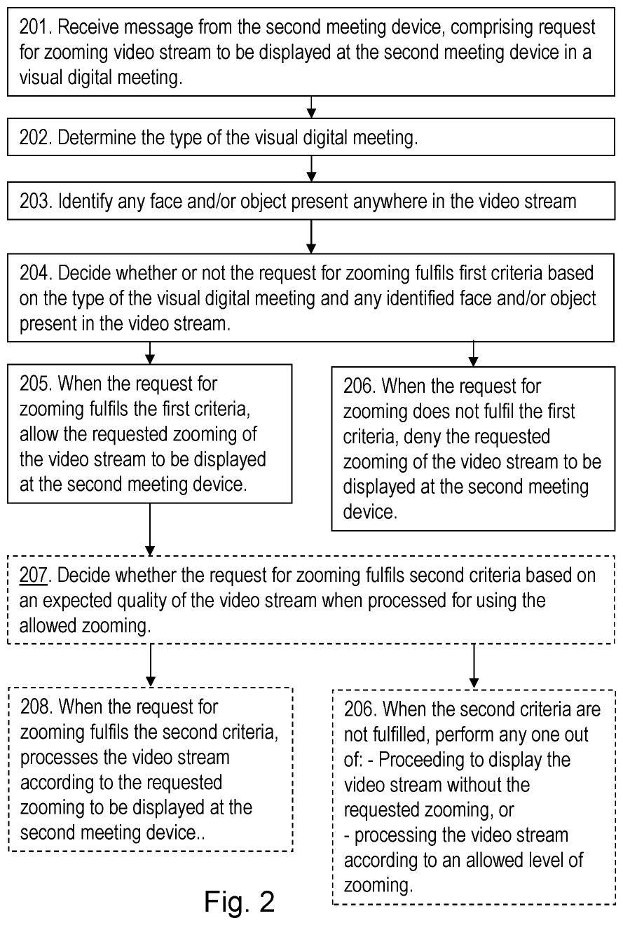

FIG. 2 shows example embodiments of a method for controlling a zoom level of a video stream provided by a first meeting device 121 in a communications network 100. The method may be performed by an apparatus 121, 130 being represented by any one out of the first device 121 or a server node 130 managing the displayed video stream. This e.g., means that method may be performed by the first device 121 or the server node 130. The word apparatus 121, 130 may thus mean the first device 121 or the server node 130. The video stream is displayed at least in a second meeting device 122 in a visual digital meeting.

A zoom level of the video stream displayed at the second meeting device 122, e.g., means to what level the video stream displayed at the second meeting device 122 is scaled up or scaled down, or in other words, to what grade the video stream displayed at the second meeting device 112 is enlarged or diminished. It may or may not relate to a resolution of the displayed video stream.

The video stream is provided by a camera 1211 targeted towards an environment, of the user 11 of the first meeting device 121, e.g. the background imagery conveyed from digital meeting applications running in user devices such as the first meeting device 121. The camera 1211 may e.g., be mounded or comprised on the first device 121. Or it may not even be installed “on” the first device 121 as such but as a free-standing separate device connected to the first device 121, for example as a web camera using a USB cable. The camera 1211 is arranged to the first meeting device 121, such that the camera 1211 targets towards an environment of the user 11. This e.g., means that the camera 1211 targets towards the user 11 and the first user's environment. This may further mean that the camera 1211 targets towards the first user's 11 environment without the first user 11 being in front of the camera 1211. E.g., if the first user 11 leaves its first meeting device 121, e.g., for fetching a cup of coffee from another room than the one the first meeting device 121 is located in, the camera 1211 targets towards an environment of a user 11, i.e. of the place where the user was positioned before he/she left.

The second meeting device 122 may in some embodiments be represented by a server device, e.g. the server node 130. This e.g., means that in an example scenario where second user 12 may not use an own device 122 but something alike a thin client or a web interface towards the meeting server node 130 in the meaning that the second user 12 is logged in onto the server node 130 directly instead of via an application on the second user's 12 device 122. In this scenario, the second user's 12 action may stem directly from the server 130 towards the first user's meeting device 121.

In this direct-to-server connection aspect, for user 122 associated devices such as camera 1221 may be connected to server 130 via some web interface, or similar. Then, any face and/or object detection-recognition associated with second user 12 may typically be executed by the server node 130 instead on device 122, and perhaps given some device capabilities, part of may be catered for by a sufficiently capable camera.

The method comprises the following actions, which actions may be taken in any suitable order. Optional actions are referred to as dashed boxes in FIG. 2.

### Action 201

The apparatus 121, 130 receives a message from the second meeting device 122. The message comprises a request for zooming the displayed video stream to be displayed at the second meeting device 122.

The request for zooming the displayed video stream to be displayed at the second meeting device 122 may be related to any one out of zooming in or zooming out.

E.g., the zooming request may be for zooming out or zooming in the video stream that is displayed at the second meeting device 122.

### Action 202

After receiving the request, the apparatus 121, 130 will now check whether the requested zoom is allowable. E.g. if the type of the visual digital meeting is a business meeting, and pictures of family members in the environment of the first user 11 are visible in the second meeting device's 121 display 1222, and must not be zoomed in or zoomed out. Or, e.g., if the type of the visual digital meeting is a private meeting with friends, and pictures of family members in the environment of the first user 11 are visible in the second meeting device's 121 display 1222 and are OK to be zoomed.

The apparatus 121, 130 determines a type of the visual digital meeting. The determining of the type of the visual digital meeting may comprise determining a relation between any one or more out of:
The first meeting device 121 and the second meeting device 122, and
a user 11 of the first meeting device 121 and a user 12 of the second meeting device 122.

The determining 202 of the type of the visual digital meeting may be based on any one or more out of:
Meeting-associated email addresses of the visual digital meeting,
a meeting subject of the visual digital meeting,
a contact list of a first user 11 of the first meeting device 121,
any one or more out of: an on-device and/or in-cloud photo album, friends lists, and social network contact entries, of the first user 11 of the first meeting device 121.

### Action 203

The apparatus 121, 130 further identifies any face and/or object present anywhere in the video stream provided by the camera 1211.

E.g. the apparatus 121, 130 may be capable of perform object recognition or object detection in the video stream.

In some embodiments, the apparatus 121, 130 identifies any face and/or object by in real-time detect, classify, and track a parallel multitude of various objects, such as e.g. a specific person, an animal, a type of vehicle etc.

E.g. the apparatus 121, 130 may thus carry out object recognition and then check thereof associated one or more first criteria e.g. comprising zoom-rules.

### Action 204

The apparatus 121, 130 decides whether or not the request for zooming fulfils one or more first criteria. The deciding is based on the determined type of the visual digital meeting and any identified face and/or object present in the video stream.

The one or more first criteria based on the determined type of the visual digital meeting, and any identified face and/or object present in the video stream may comprise any one or more out of:
whether or not an identified face and/or object is decided by the first user 11 to be hidden,
whether or not an identified face belongs to a kid,
whether or not an identified face belongs to a family member,
whether or not the determined type of the visual digital meeting is a professional visual digital meeting,
whether or not the determined type of the visual digital meeting is a private visual digital meeting.
whether or not a determined relation between the first meeting device 121 and the second meeting device 122 is unknown, and
whether or not a determined relation between the first user 11 of the first meeting device 121 and the second user 12 of the second meeting device 122 is unknown.

### Action 205

When the request for zooming fulfils the one or more first criteria, the apparatus 121, 130 allows the requested zooming of the displayed video stream to be displayed at the second meeting device 122.

### Action 206

When the request for zooming does not fulfil the one or more first criteria, the apparatus 121, 130 denies the requested zooming of the displayed video stream to be displayed at the second meeting device 122.

In some first example scenarios the requested zooming is allowed, and in these first example scenarios the Actions 207-209 may be performed.

### Action 207

The apparatus 121, 130 may further decide whether or not the request for zooming fulfils one or more second criteria based on an expected quality of the video stream when processed for using the allowed zooming. This is e.g., to check if the requested zooming provides appropriate quality when displayed for the second user 12.

The one or more second criteria based on an expected quality of the video stream may comprise any one or more out of:
Whether or not a video rate and/or video resolution of the received video applying the requested zooming of the displayed video stream to be displayed at the second meeting device 122 is above a threshold. This is e.g., to check if the expected quality when zoomed is good enough.
And/or, whether or not a video rate and/or video resolution of the video stream currently displayed at the second meeting device 122 is high enough to allow for the requested zooming. This is e.g., to check if the current quality of the video stream allows an expected quality that is good, e.g., high, enough for the requested zooming of the video stream when applied.

The video rate mentioned above may e.g., be any one out of a video bit rate or a video frame rate. A video bitrate may mean a number of bits per second that is produced by the video encoder. It generally determines the size and quality of the video and the higher bitrate the better quality. A video frame rate may mean the number of captured images that makes up the video, 24, 30 and 60 frames per second are common frame rates.

A video resolution may mean a number of pixels that could be displayed in the width and height dimensions. It may also refer to the number of pixels contained in each video frame.

### Action 208

When the request for zooming fulfils the one or more second criteria, the apparatus 121, 130 processes the video stream according to the requested zooming to be displayed at the second meeting device 122.

### Action 209

When the request for zooming does not fulfil the one or more second criteria, the apparatus 121, 130 may perform 209 any one out of:
proceeding to display the video stream without the requested zooming at the second meeting device 122, or
processing the video stream according to an allowed and/or available level of zooming to be displayed at the second meeting device 122. This e.g. means that the apparatus 121, 130 may determine to how much zooming that is possible when still fulfilling the one or more second criteria.

The above embodiments will now be further explained and exemplified below. The embodiments below may be combined with any suitable embodiment above.

In context of a digital meeting hosting multiple users such as e.g. the first user 11 and the second user 12, the users' devices such as the first meeting device 121 and the second meeting device 122, may each run a meeting application that may be connected to at least one managing entity, that may be located in a managing server and/or a controlling node e.g. the apparatus 121, 130, such as the server node 130 or the first meeting device 121. The apparatus 121, 130 such as its managing entity may control inbound and/or outbound video streams to and/or from its managed users such as e.g. the first user 11 and the second user 12.

In some embodiments, the apparatus 121, 130 such as its managing entity may control e.g. the zoom level into a video media stream by sending to the recording camera 1211, an explicit control signal that the apparatus 121, 130 has determined depending on a requested input from at least one viewing device, e.g. the request from the second meeting device 122, for zooming the displayed video stream to be displayed at the second meeting device 122.

In some other embodiments, the apparatus 121, 130 such as its managing entity may pass e.g. a zoom level control signal originating from at least one viewing device such as the second meeting device 122, further towards the recording device, such as the first meeting device 121 which in turn may manage its camera 1211 operation according to associated obtained control signal and provide media to requesting parties accordingly.

This relates to and may be combined with Action 205 described above.

In some embodiments, the apparatus 121, 130 such as its managing entity may also hold capabilities of face and/or object identification and classification in terms of identifying and/or classifying objects in respective users' e.g. the first user's 11 environment, also referred to as background imagery conveyed from digital meeting applications running in user devices, such as the first meeting device 121. Depending on device capabilities, said meeting devices, such as the first meeting device 121 (e.g. a smartwatch, tablet, a smartphone, or a laptop, etc.) may typically also cater for object recognition associated with e.g. its captured media streams associated with the meeting. This relates to and may be combined with Action 203 described above.

The apparatus 121, 130 such as its managing entity may also hold capabilities of determining participants relations, e.g. the first and second users' 11, 12 relation to e.g. faces and/or objects detected in the user environment media flow. E.g. the faces and/or objects detected in the environment of the user 11 of the first meeting device 121. For example to detect and determine a detected face to belong to a kid/family member, etc. in related aspect, to determine if the visual digital meeting is of private or business/corporate context, e.g. via email addressed, time of day, meeting subject, etc. and combinations thereof. This relates to and may be combined with Action 202 described above.

The apparatus 121, 130 such as the server node 130 or the first meeting device 121 may then deduct e.g. the following. This relates to and may be combined with Action 204 described above. It should be noted that the words environment and background may be used interchangeably herein.

The apparatus 121, 130 may deduct what faces or objects that are present in a first user's 11 environment.

The apparatus 121, 130 may further determine relations between first user 11 and other meeting participants such as the second user 12. For example type of meeting and relations in context of e.g.:
Private meeting with family and friends.
Professional, business-related relations.
Unknown relations.
For example, extracted by device of the apparatus 121, 130, e.g. its managing entity, from information in meeting-associated email addresses, meeting subject, first-user contact list information, on-device/in-cloud photo album, friend lists, direct messages, such as e.g. iMessage's, SMSs, etc., social network contact entries, etc.

In context of having determined first user's 11 and other meeting participants' relations e.g. the second user 12, and assuming that the apparatus 121, 130 such as the server node 130 or the first meeting device 121 have detected faces/objects in the first user 11 environment media stream and have determined respective relations, then the apparatus 121, 130 such as the server node 130 or the first meeting device 121 may determine what detected object that may be allowed or prohibited from being subject to renewed media stream with zoomed, e.g. improved resolution, in relation to items, faces and/or objects such as:
list of user-preferred settings, considering
individuals, group of people, family members, or
class of non-personal objects,
etc.

Where each entry above is associated with a highest allowed remote-requested zoom-level, relating to the one or more first criteria.

Zoom information about the expected quality of the video stream may be obtained by the second user 12 of second meeting device 122 zooms in on the video stream content provided from the first meeting device 121, e.g., by marking an interesting area in the video window, where said zoom action may be characterized by e.g. any one or more out of pixel and/or screen coordinates of the zooming area, and level of zoom and zoom level quality. The second meeting device 122 then provides at least one of server node 130 or first meeting device 121 with the above zoom information.

The apparatus 121, 130 such as the server node 130 or the first meeting device 121 may then detect that the second user 12 of second meeting device 122 zooms in the video stream obtained from zoom-request commands from second meeting device 122 via a zoom information message from the second meeting device 122.

The apparatus 121, 130 such as the server node 130 or the first meeting device 121 may then determine that certain faces or object in media stream being subject to the zooming action. E.g. that a certain face and/or object is inside a pixel area to be zoomed, etc.

The apparatus 121, 130 such as the server node 130 or the first meeting device 121 may then evaluate if the detected object has certain relation to second requesting user 12.

The apparatus 121, 130 such as the server node 130 or the first meeting device 121 may then determine whether the requested zoom shall be allowed or denied. This relates to and may be combined with Action 204 described above.

This may be determined according to e.g. any one out of:
In general for said video stream,
or if to allow zoom to some specific zoom level,
or if to allow zoom to some specific zoom level in association to relation between requesting second meeting device 122 and zoom-allowance definitions decided by the first user 11, and e.g. entered into the apparatus 121, 130 such as the server node 130 or the first meeting device 121 with relation to targeted objects and/or persons faces, or
allowed zoom levels may furthermore differ for different objects present in same media flow; e.g. for participant X, such as the second user 12, zoom on family member allowed to one level Xa, whereas zoom on dog or flower is allowed to another level Xb (>Xa), etc.

The below concerns some second embodiments. These relate to and may be combined with Action 207-209 described above.

When the requested zooming is allowed, the apparatus 121, 130 may further decide whether or not the request for zooming fulfils the one or more second criteria based on an expected quality of the video stream when processed for using the allowed zooming.

The apparatus 121, 130 such as the server node 130 or the first meeting device 121 may then, based on the zoom information and the current received resolution with relation to the video that is zoomed and the video rate that is sent to the zooming application/client, further decide any one or more out of:
if the video rate, i.e. communication link performance, towards the allowed zooming client, e.g. the second meeting device 122, is high enough to allow for the requested zooming, and then
if also the current received video resolution is high enough to allow for zooming with respect to the zoom info rate towards the zooming client good enough to allow for zooming, continue next step.
Else, reject zoom, and possibly send a control message to providing device to increase video resolution and/or send a control message to the zooming client that “zoom is not available at this moment”.

When the requested zooming is not allowed, the apparatus 121, 130 may further perform any one or more out of:
provide requesting device with a zoom-request-related control message, where the control message may include a reason for no-zoom, e.g. denied object and/or zoom level, and/or
process the outbound media content, providing essentially a new video encoding of the zoomed area that has a higher resolution of the zoomed area and start sending the new zoomed video to the requesting second meeting device 121.

The second embodiments of the method may involve both a video streaming client and a video streaming server and messages transferred between the two entities.

The second user 12 may zoom in on the video content using the video application on second meeting device 122.

Zoom level and associated quality are then evaluated by the apparatus 121, 130 such as the server node 130 or the first meeting device 121, as the second user 12 zooms into the content. If zoom level quality is determined insufficient, the apparatus 121, 130 may provide zoom information to the second meeting device 122, such as video play-out time, pixel/screen coordinates of the zoom, level of zoom and associated zoom level quality and an identifier of the content being viewed to the media-providing video server.

Based on the obtained media zoom information provided from the application of the second meeting device 122, the apparatus 121, 130, such as the server node 130 or the first meeting device 121, determines which video resolution and video content, e.g. higher resolution video content of the current and upcoming play-out of the video, to provide to the zooming requesting second meeting device 122, e.g. the zooming requesting client of the second meeting device 122.

The apparatus 121, 130, such as the server node 130 or the first meeting device 121, may then send the video stream to the second meeting device 122 client, according to the allowed zooming or a new or updated Media Presentation Description (MPD) representing the zoomed content that the client should request following the normal streaming procedure.

The second meeting device 122 client may then retrieve the “zoomed” content, or via a new updated MPD, and eventually plays-out obtained content to its user.

The second embodiments of the method involve both the video streaming client and a video streaming server, and messages transferred between the two nodes, e.g. in the below example of stepwise approach.

In the second embodiments the video streaming client may e.g. be comprised in the second meeting device 122 and the video streaming server may e.g. be comprised e.g. in the apparatus 121, 130, such as the server node 130 or the first meeting device 121

The steps are referred to within the below parentheses:
(1) The second user 12 of the second meeting device 122, e.g. a smartwatch, smartphone, tablet, laptop, Apple TV, Chromecast, etc., zooms in on the video content using the video application. The application may be a standalone dedicated application, e.g., YouTube app, for the service or a web-browser application.
(2) The apparatus 121, 130 such as the server node 130 or the first meeting device 121 or its application evaluates the Zoom Level Quality, e.g. further triggered by any one or more out of:
   The application has detected user starts zooming into the content,
   the application has detected user zoomed content>zoom-level threshold, e.g. related to the one or more second criteria,
   the application evaluates zoom-level periodically, given a zoom parameter that in some embodiments is related to the zoom-level threshold. The zoom parameter may e.g. comprise any one or more out of:
      a speed of zoom slow zoom or rapid zoom,
      a history of the second user's 12 zoom behaviour, e.g. incl. expected duration of zooming, etc.,
      a second user 12 context, e.g. home, business, vehicle, etc.,
      single- or multi-user environment, e.g. watching alone or with friends, e.g. sports, and/or
      type of content, such as sports event, detailed/less detailed content, etc.
(3) The zoom level quality may be defined according to any one or more out of:
   “pixels per area unit”
   “pixels per area unit”/“native screen resolution”>% ratio_threshold
   “pixels per playout area”
   Etc.
(4) The apparatus 121, 130 such as the server node 130 or the first meeting device 121 may then evaluate a Zoom Level Quality (ZLQ) in respect to state of the video streamed media and:
   If the Zoom Level Quality is determined OK, i.e., if the request for zooming fulfils the one or more second criteria, then go back to step (1) and continue evaluation.
   If the Zoom Level Quality is determined Not OK, i.e., the request for zooming does not fulfil the one or more second criteria, the second meeting device 122, e.g. its streaming application, sends zooming information to the apparatus 121, 130 such as the server node 130 or the first meeting device 121. The zooming information may include any one or more out of:
   A time stamp where video is zoomed,
   pixel/screen coordinates of the zooming area,
   a level of zoom,
   zoom level quality,
   optionally also the second meeting device's 122 native screen resolution,
(5) The apparatus 121, 130 such as the server node 130 or the first meeting device 121 may then, based on obtained zoom information from the second meeting device 122, determine which video resolution and video content, such as e.g., higher resolution video content of the current and upcoming play-out of the video stream, to provide to the requesting second meeting device 122 such as its client.
(6) The apparatus 121, 130 such as the server node 130 or the first meeting device 121 may then send the decided “zoomed” content to the second meeting device 122, or a new or updated Media Presentation Description (MPD) representing the zoomed content that the client should request following the normal streaming procedure.
(7) The second meeting device 122 receives the “zoomed” content and plays-out, i.e. displays the obtained media stream content to the second user 12.
(8) Go back to (1).

In case that the second user 12 zooms out, the second meeting device 122 may switch back to the previous MPD. Or the steps 1-6 may be followed also in case of “zoom out”.

### Further Variants of the Second Embodiments—ZLQ

The Zoom Level Quality may be considered as a measure reflecting how “much” a specific media is zoomed, relating to the one or more second criteria. The “how much” aspect may be considered in respect to e.g., Pixels Per Inch (PPI) and Pixels Per Centimeter (PPCM or pixels/cm). The PPI and PPCM are measurements of the pixel density of an electronic image device.

In a further aspect associated to pixel density relating to the one or more second criteria, also a relative measure relating PPI to the second meeting device's 122 native resolution may be considered. In this aspect the second meeting device 122 e.g. its media application, may also provide said device's native resolution to the apparatus 121, 130 such as the server node 130 or the first meeting device 121.

Related to the second meeting device's 122 native resolution; a typical termination condition for the provide-new-content-with-requested-zoom-level may be that the apparatus 121, 130 such as the server node 130 or the first meeting device 121 may then determine that further user-requested zoom will not be useful since device maximum native resolution will be exceeded.

### Further Variants of the Second Embodiments—Asymmetrical Aspects of Zoom

Above discussed zoom quality level (ZLQ) may in a basic solution consider symmetric zoom, but other per-directions (horizontal, vertical) may also be considered as one of the second criteria e.g., in a scenario where screen design and/or X:Y aspect ratio suggests a non-symmetric zoom execution. The latter may be the typical case where a user free-form pinch zoom at the screen and when “orientation of pinch-grip” (in the horizontal, vertical, or any direction in-between) may further indicate a preferred zoom orientation.

Further variants of the second embodiments—expected duration of a certain zoom level may also be considered as one of the second criteria.

This is e.g. to mitigate excessing re-rendering of media content only being used for very short time periods. Typically, second meeting device 122 and the second UE 12 may with pinch-zoom operation overshoot a desired high zoom level and adjust back to a less extensive level after very short time.

Then, the apparatus 121, 130 such as the server node 130 or the first meeting device 121 may then, e.g. its media server may recognize the second meeting device's 122 zoom-overshoot pattern and not send a request containing zoom info that is an over-shoot or in case of media sever not to provide over-shoot resolution video stream.

Further variants of the second embodiments—other types of media.

The same procedure may be applicable e.g. to video-on-demand (pre-recorded material) streaming, and also for “live” streaming video where material provided for view some May 10, 2020-30 seconds after being captured.

The same procedure may be used for pictures in a scenario where image content is stored at a server in a resolution higher than currently digested by the second meeting device 122.

In a similar aspect as for video-on-demand, same type of content may be provided in context of Extended Reality (XR) HMDs where the second user 12 consumes some pre-rendered digital media in a synthetic/digital environment may face subject of similar zoom-until-pixelated impairments as for ordinary smartwatch, smartphone, laptop-screen or tablet-viewed content.

Also related to XR, in rendering av textures, a similar approach may be applicable in a scenario where XR object content textures may be subject to “zooming actions” as e.g., an in-XR user moves sufficiently close to a texturized object.

To perform the method actions above, the apparatus 121, 130 is configured to control a zoom level of a video stream to be provided by the first meeting device 121 in the communications network 100. The video stream is to be displayed at least in a second meeting device 122 in a visual digital meeting. The video stream is arranged to be provided by a camera 1211 targeted towards an environment of a user 11 of the first meeting device 121. The apparatus 121, 130 may be represented by any one out of the first device 121 or a server node 130 managing the displayed video stream. The second meeting device 122, may be adapted to be represented by a server device.

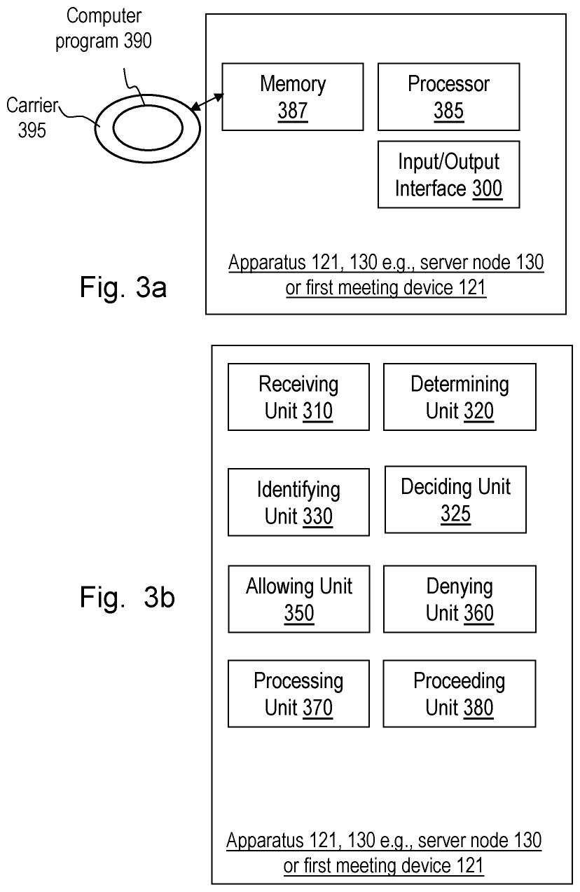

The apparatus 121, 130 may comprise an arrangement depicted in FIGS. 3a and 3b.

The first apparatus 121, 130 may comprise an input and output interface 300 configured to communicate with network entities such as e.g. the second meeting device 122. The input and output interface 300 may comprise a wireless receiver not shown and a wireless transmitter not shown.

The apparatus 121, 130 may further be configured to, e.g. by means of a receiving unit 310 in the apparatus 121, 130, receive a message from the second meeting device 122, which message is adapted to comprise a request for zooming the displayed video stream to be displayed at the second meeting device 122.

The request for zooming the displayed video stream to be displayed at the second meeting device 122 may be adapted to be related to any one out of zooming in or zooming out.

The apparatus 121, 130 may further be configured to, e.g. by means of a determining unit 320 in the apparatus 121, 130, determine a type of the visual digital meeting.

The apparatus 121, 130 may further be configured to, e.g. by means of the determining unit 320 in the apparatus 121, 130, determine the type of the visual digital meeting by determining a relation between any one or more out of:
the first meeting device 121 and the second meeting device 122, and
a user 11 of the first meeting device 121 and a user 12 of the second meeting device 122.

The apparatus 121, 130 may further be configured to, e.g. by means of the determining unit 320 in the apparatus 121, 130, determine of the type of the visual digital meeting based on any one or more out of:
meeting-associated email addresses of the visual digital meeting,
a meeting subject of the visual digital meeting,
a contact list of a first user 11 of the first meeting device 121,
any one or more out of: an on-device and/or in-cloud photo album, friend lists, social network contact entries, of the first user 11 of the first meeting device 121.

The apparatus 121, 130 may further be configured to, e.g. by means of an identifying unit 330 in the apparatus 121, 130, identify any face and/or object present anywhere in the video stream provided by the camera 1211.

The apparatus 121, 130 may further be configured to, e.g. by means of a deciding unit 340 in the apparatus 121, 130, decide whether or not the request for zooming fulfils one or more first criteria based on the determined type of the visual digital meeting and any identified face and/or object present in the video stream.

The apparatus 121, 130 may further be configured to, e.g. by means of an allowing unit 350 in the apparatus 121, 130, when the request for zooming fulfils the one or more first criteria allow the requested zooming of the displayed video stream to be displayed at the second meeting device 122.

The apparatus 121, 130 may further be configured to, e.g. by means of a denying unit 360 in the apparatus 121, 130, when the request for zooming does not fulfil the one or more first criteria deny the requested zooming of the displayed video stream to be displayed at the second meeting device 122.

The apparatus 121, 130 may further be configured to, e.g. by means of the deciding unit 325 in the apparatus 121, 130, when the requested zooming is allowed, decide whether or not the request for zooming fulfils one or more second criteria based on an expected quality of the video stream when processed for using the allowed zooming.

The one or more second criteria based on an expected quality of the video stream may be adapted to comprise any one or more out of:
whether or not a video rate and/or video resolution of the received video applying the requested zooming of the displayed video stream to be displayed at the second meeting device 122 is above a threshold,
whether or not a video rate and/or video resolution of the video stream currently displayed at the second meeting device 122 is high enough to allow for the requested zooming.

The apparatus 121, 130 may further be configured to, e.g. by means of a processing unit 370 in the apparatus 121, 130, when the request for zooming fulfils the one or more second criteria, process the video stream according to the requested zooming to be displayed at the second meeting device 122.

The apparatus 121, 130 may further be configured to when the request for zooming does not fulfil the one or more second criteria, perform any one or more out of:
proceeding to display the video stream without the requested zooming at the second meeting device 122, e.g. by means of a proceeding unit 380 in the apparatus 121, 130, and
processing the video stream according to an allowed and/or available level of zooming to be displayed at the second meeting device 122, e.g. by means of the processing unit 370 in the apparatus 121, 130.

The one or more first criteria based on the determined type of the visual digital meeting, and any identified face and/or object present in the video stream may be adapted to comprise any one or more out of:
whether or not an identified face and/or object is decided by the first user 11 to be hidden,
whether or not an identified face belongs to a kid,
whether or not an identified face belongs to a family member,
whether or not the determined type of the visual digital meeting is a professional visual digital meeting,
whether or not the determined type of the visual digital meeting is a private visual digital meeting.
whether or not a determined relation between the first meeting device 121 and the second meeting device 122 is unknown,
whether or not a determined relation between the first user 11 of the first meeting device 121 and the second user 12 of the second meeting device 122 is unknown.

The embodiments herein may be implemented through a respective processor or one or more processors, such as the processor 385 of a processing circuitry in the first apparatus 121, 130 depicted in FIG. 3a, together with respective computer program code for performing the functions and actions of the embodiments herein. The program code mentioned above may also be provided as a computer program product, for instance in the form of a data carrier carrying computer program code for performing the embodiments herein when being loaded into the apparatus 121, 130. One such carrier may be in the form of a CD ROM disc. It is however feasible with other data carriers such as a memory stick. The computer program code may furthermore be provided as pure program code on a server and downloaded to the apparatus 121, 130.

The apparatus 121, 130 may further comprise a memory 387 comprising one or more memory units. The memory 387 comprises instructions executable by the processor in the apparatus 121, 130. The memory 387 is arranged to be used to store e.g., information, indications, data, presentations, configurations, and applications to perform the methods herein when being executed in the apparatus 121, 130.

In some embodiments, a computer program 390 comprises instructions, which when executed by the respective at least one processor 385, cause the at least one processor of the first device 121 to perform the actions above.

In some embodiments, a respective carrier 395 comprises the respective computer program 390, wherein the carrier 395 is one of an electronic signal, an optical signal, an electromagnetic signal, a magnetic signal, an electric signal, a radio signal, a microwave signal, or a computer-readable storage medium.

Those skilled in the art will appreciate that the units in the apparatus 121, 130 described above may refer to a combination of analog and digital circuits, and/or one or more processors configured with software and/or firmware, e.g. stored in the apparatus 121, 130, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

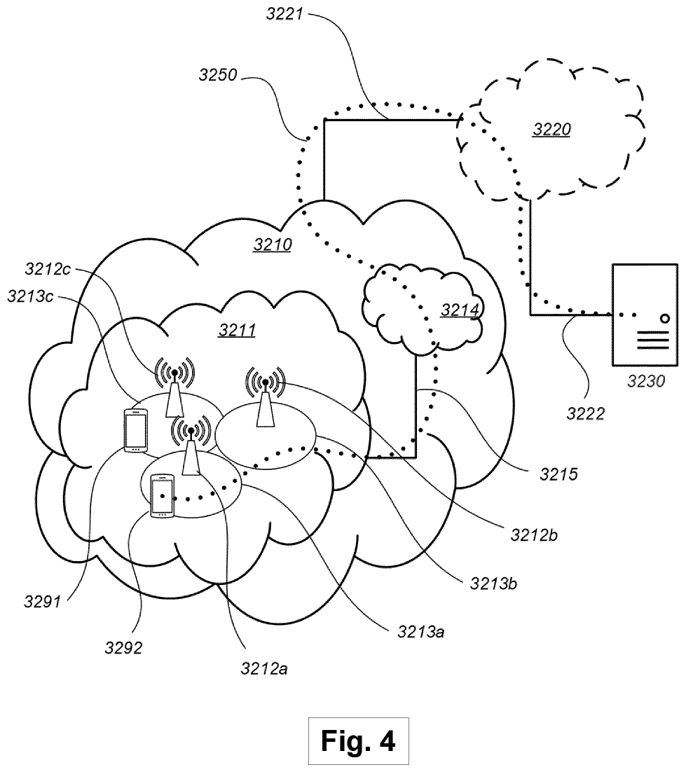

With reference to FIG. 4, in accordance with an embodiment, a communication system includes a telecommunication network 3210, such as a 3GPP-type cellular network, e.g. communications network 100, which comprises an access network 3211, such as a radio access network, and a core network 3214. The access network 3211 comprises a plurality of base stations 3212a, 3212b, 3212c, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c, e.g. the first meeting device 121. A second UE 3292 such as a Non-AP STA in coverage area 3213a is wirelessly connectable to the corresponding base station 3212a e.g. the second device 122. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

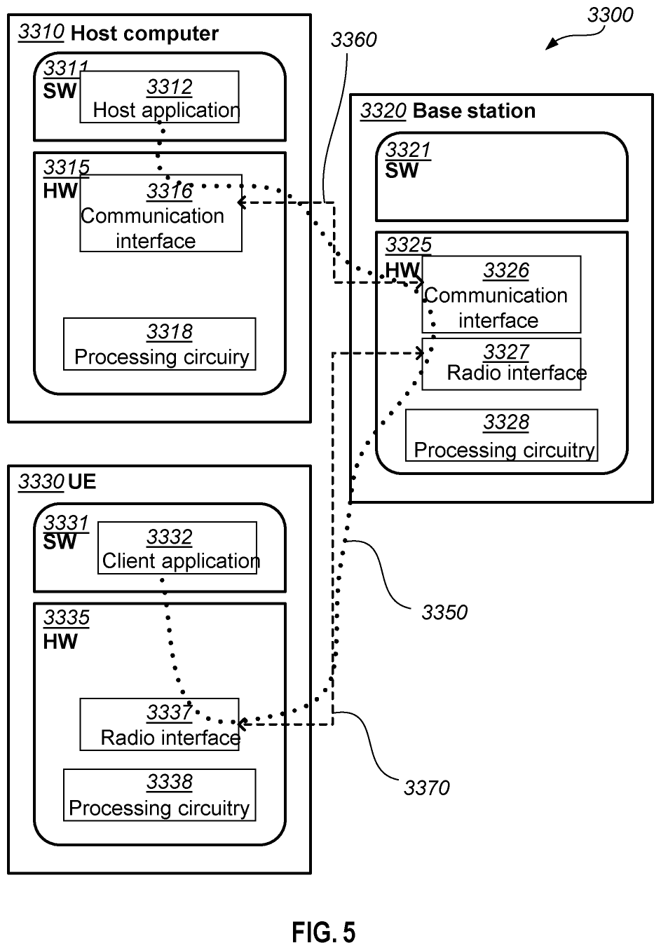

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 20) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the latency and user experience and thereby provide benefits such as reduced user waiting time, better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

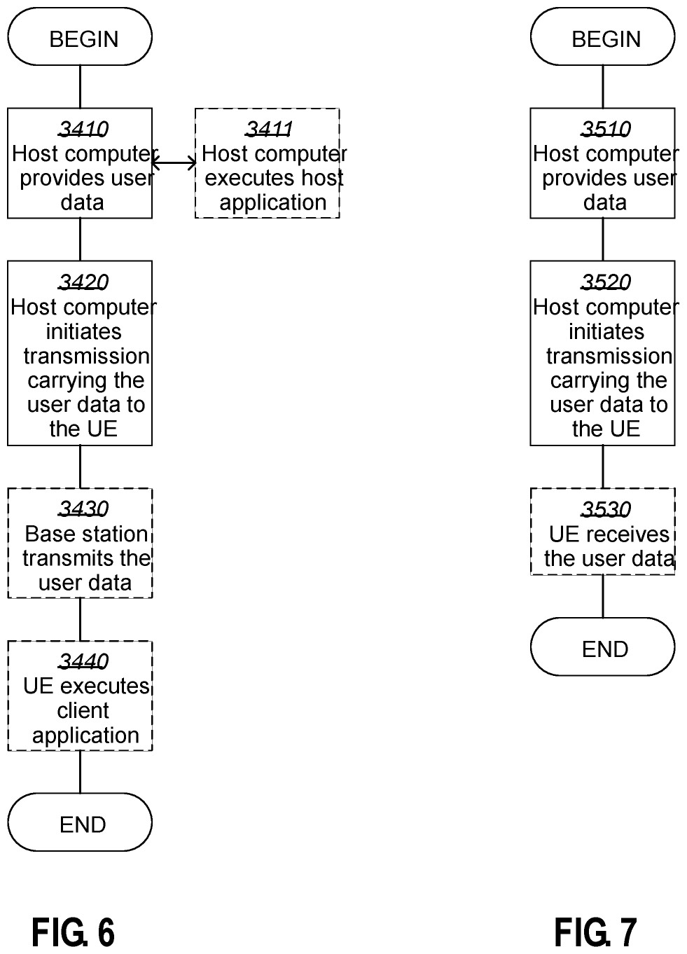

FIG. 6 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 6 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 7 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 7 will be included in this section. In a first step 3510 of the method, the host computer provides user data. In an optional sub step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

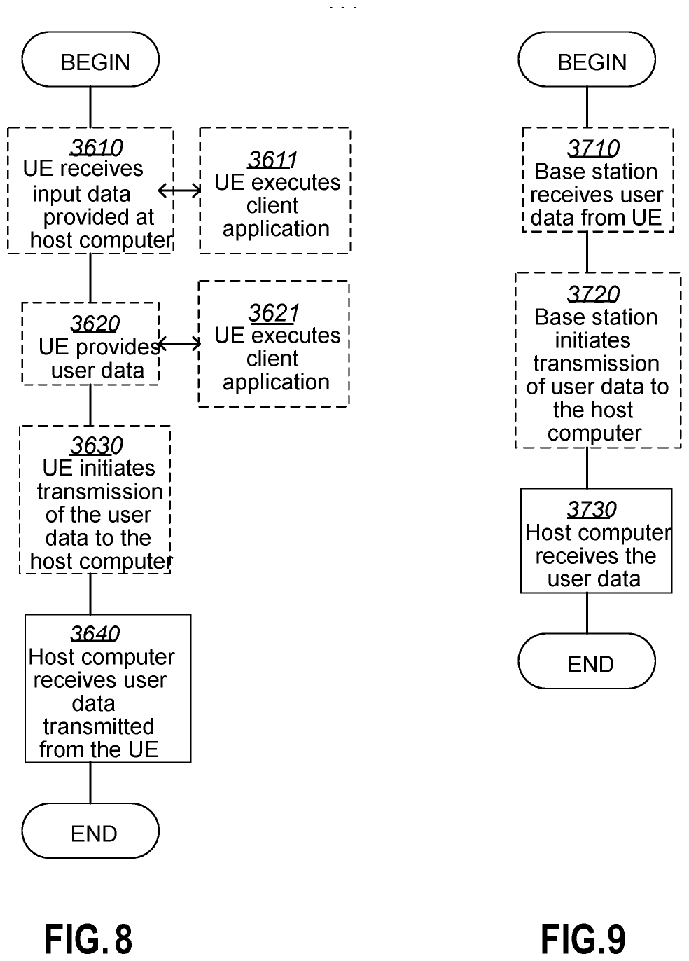

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 8 will be included in this section. In an optional first step 3610 of the method, the UE receives input data provided by the host computer. Additionally or alternatively, in an optional second step 3620, the UE provides user data. In an optional sub step 3621 of the second step 3620, the UE provides the user data by executing a client application. In a further optional sub step 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub step 3630, transmission of the user data to the host computer. In a fourth step 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 9 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

| Abbreviation | Explanation |
|---|---|
| CCD | charge-coupled device (CCD) |
| CMOS | Complementary Metal Oxide Semiconductor |
| MPD | Media Presentation Description |
| MPD | Media Presentation Description |
| PPCM | pixels/cm |
| PPI | pixels per inch |
| ZLQ | Zoom Level Quality |

1. A method for controlling a zoom level of a video stream provided by a first computing device in a communications network, which video stream is displayed at least by a second computing device operating to provide a visual digital meeting, and which video stream is provided by a camera associated with the first computing device, the method comprising:
receiving from the second computing device a request for zooming the video stream to be displayed at the second computing device,
determining a type of the visual digital meeting,
identifying presence of a face and/or object in the video stream provided by the camera,
deciding whether or not the request for zooming fulfils one or more first criteria based on the determined type of the visual digital meeting and the identified presence of the face and/or object in the video stream,
when the request for zooming fulfils the one or more first criteria allowing the requested zooming of the video stream to be displayed at the second computing device, and
when the request for zooming does not fulfil the one or more first criteria denying the requested zooming of the video stream from being displayed at the second computing device.

2. The method according to claim 1, wherein the method is performed by the first computing device, the second computing device, or a server node managing the video stream.

3. The method according to claim 1, wherein the determining of the type of the visual digital meeting comprises determining any one or more out of:
a relation between the first computing device and the second computing device, and
a relation between a user of the first computing device and a user of the second computing device.

4. The method according to claim 1, wherein when the requested zooming is allowed, the method further comprising:
deciding whether or not the request for zooming fulfils one or more second criteria based on an expected quality of the video stream when processed for using the allowed zooming, and
when the request for zooming fulfils the one or more second criteria, processing the video stream according to the requested zooming to be displayed at the second computing device,
when the request for zooming does not fulfil the one or more second criteria, performing any one or more out of:
proceeding to display the video stream without the requested zooming at the second computing device, and
processing the video stream according to an allowed and/or available level of zooming to be displayed at the second computing device.

5. The method according to claim 1, wherein the one or more first criteria based on the determined type of the visual digital meeting, and any identified presence of a face and/or object in the video stream comprise any one or more out of:
whether or not presence of a face and/or object has been indicated by a first user of the first computing device to be hidden,
whether or not a face identified as present belongs to a kid,
whether or not a face identified as present belongs to a family member of the first user of the first computing device,
whether or not the determined type of the visual digital meeting is associated with professional visual digital meeting,
whether or not the determined type of the visual digital meeting is associated with private visual digital meeting,
whether or not a determined relation between the first computing device and the second computing device is unknown,
whether or not a determined relation between the first user of the first computing device and a second user of the second computing device is unknown.

6. The method according to claim 1, wherein the determining of the type of the visual digital meeting is based on any one or more out of:
meeting-associated email addresses of the visual digital meeting,
a meeting subject of the visual digital meeting,
a contact list of a first user of the first computing device,
any one or more out of: an on-device and/or in-cloud photo album, friend lists, social network contact entries, of the first user of the first computing device.

7. The method according to claim 4, wherein the one or more second criteria based on an expected quality of the video stream comprises any one or more out of:
whether or not a resolution of the received video applying the requested zooming of the displayed video stream to be displayed at the second computing device is above a threshold,
whether or not a resolution of the video stream currently displayed at the second computing device is high enough to allow for the requested zooming.

8. The method according to claim 1, wherein the second computing device, is a server device.

9. The method according to claim 1, wherein the request for zooming the displayed video stream to be displayed at the second computing device is a request for zooming in.

10. A computer program product comprising a non-transitory computer readable medium storing instructions, which when executed by a processor, causes the processor to perform actions according to claim 1.

11. (canceled)

12. An apparatus configured to control a zoom level of a video stream provided by a first computing device, which video stream is to be displayed at least by a second computing device operating to provide a visual digital meeting, and which video stream is provided by a camera associated with the first computing device, the apparatus further being configured to:
receive from the second computing device a request for zooming the video stream provided by first computing device,
determine a type of the visual digital meeting,
identify presence of a face and/or object in the video stream provided by the camera,
decide whether or not the request for zooming fulfils one or more first criteria based on the determined type of the visual digital meeting and any identified face and/or object present in the video stream,
when the request for zooming fulfils the one or more first criteria allow the requested zooming of the video stream to be displayed at the second computing device, and
when the request for zooming does not fulfil the one or more first criteria deny the requested zooming of the video stream from being displayed at the second computing device.

13. The apparatus according to claim 12, wherein the apparatus is comprised in the first computing device, the second computing device, or a server node managing the video stream.

14. The apparatus according to claim 12, wherein the apparatus is configured to determine the type of the visual digital meeting by determining any one or more out of:
a relation between the first computing device and the second computing device, and
a relation between a user of the first computing device and a user of the second computing device.

15. The apparatus according to claim 12 wherein when the requested zooming is allowed, the apparatus further being configured to:
decide whether or not the request for zooming fulfils one or more second criteria based on an expected quality of the video stream when processed for using the allowed zooming, and
when the request for zooming fulfils the one or more second criteria, process the video stream according to the requested zooming to be displayed at the second computing device,
when the request for zooming does not fulfil the one or more second criteria, perform any one or more out of:
proceeding to display the video stream without the requested zooming at the second computing device, and
processing the video stream according to an allowed and/or available level of zooming to be displayed at the second computing device.

16. The apparatus according to claim 12, wherein the one or more first criteria based on the determined type of the visual digital meeting, and any identified presence of a face and/or object in the video stream, comprise one or more out of:
whether or not presence of a face and/or object has been indicated by a first user of the first computing device to be hidden,
whether or not a face identified as present belongs to a child, whether or not a face identified as present belongs to a family member of the first user of the first computing device,
whether or not the determined type of the visual digital meeting is associated with a professional visual digital meeting,
whether or not the determined type of the visual digital meeting is associated with a private visual digital meeting,
whether or not a determined relation between the first computing device and the second computing device is unknown,
whether or not a determined relation between the first user of the first computing device and a second user of the second computing device is unknown.

17. The apparatus according to claim 12, wherein the apparatus further is configured to determine of the type of the visual digital meeting based on any one or more out of:
meeting-associated email addresses of the visual digital meeting,
a meeting subject of the visual digital meeting,
a contact list of a first user of the first computing device,
any one or more out of: an on-device and/or in-cloud photo album, friend lists, social network contact entries, of the first user of the first computing device.

18. The apparatus according to claim 15, wherein the one or more second criteria based on an expected quality of the video stream comprise one or more out of:
whether or not a resolution of the video applying the requested zooming of the displayed video stream to be displayed at the second computing device is above a threshold,
whether or not a resolution of the video stream currently displayed at the second computing device is high enough to allow for the requested zooming.

19. (canceled)

20. The apparatus according to claim 12, wherein the request for zooming is a request for zooming in.
